(19) United States
(12) Patent Application Publication
(10) Pub. No.: US 2008/0224927 A1
(43) Pub. Date: Sep. 18, 2008

(54) DIVERSITY MODULE BETWEEN GPS ANTENNAS, WITH RECEIVER PROTECTION AND INTEGRATED ALARM SIGNAL

(76) Inventor: ESPEDITO ALVES DE ABREU, Sao Paulo (BR)

Correspondence Address: NOTARO AND MICHALOS, 100 DUTCH HILL ROAD, SUITE 110, ORANGEBURG, NY, 10962-2100, US

(21) Appl. No.: 12/026,095

(22) Filed: Feb. 5, 2008

(30) Foreign Application Priority Data
Mar. 14, 2007 (BR) PI 0700953-4

(51) Int. Cl. G01S 1/00

(52) U.S. Cl. 342/357.12

(57) ABSTRACT

The present Invention is about the Diversity Module Between GPS Antennas, with Receiver Protection and Integrated Alarm Signal (1), characterized by comprising a GPS receiver (2) and antennas (3), emphasizing that the combined signals of antennas 1 and 2 (3) transmit the signals to the two receivers (2), which receives the signals from four satellites (5) and (6). In a second situation, if the GPS antenna (3) fails, the test is not lost because the signal is simultaneously received by two GPS antennas (3). In another situation, if one of the GPS antennas (3) fails, a failure signal is automatically sent to the failure management (7) indicating that antenna (3) and not the GPS receiver (2), so the controller does not switch to backup. In a fourth situation, the failed antennas (3) are detected and sent through signals to a microwave (8) or optic fiber radio, which transmits it up to the failure management (7) network that, after being viewed moves a technician to the location to repair the detected failures,

### 1. INTRODUCTION

The present descriptive report of the Patent of Invention is about the Diversity Module Between GPS Antennas, with Receiver Protection and Integrated Alarm Signal, characterized by comprising a system that works with two receiver modules and two antennas, protecting the system (GPS) receivers, eliminating its obstruction problems, with an alarm-for possible failures and switching failures that may occur, as well as generates a monitoring alarm in the event of failures.

Furthermore, it is worth emphasizing that this module imposes technicians to inspect the removal of alarms, and it is applicable in mobile or fixed use in Radio Base Stations (RBS).

### 2. FIELD OF APPLICATION

The field of application of this Diversity Module Between GPS Antennas, with Receiver Protection and Integrated Alarm Signal, refers to the combined use of GPS receivers instead of switching on a single antenna; with this circuit it is possible to switch on two antennas and create a spatial diversity making it possible to place the antennas at different positions or points.

### 3. PURPOSE

The purpose of this Diversity Module Between GPS Antennas, with Receiver Protection and Integrated Alarm Signal, as the name implies, is to solve switching problems of the radio base station controllers by concentrating the two GPS signal reception antennas, combining the radio frequency of both and then distributing them to the two station controllers.

### 4. STATE OF TECHNIQUE

In the state of technique, it is observed that the present technical means used for accurate localization on the earth is performed through the Global Positioning System (GPS), which is made up of 24 earth orbit satellites that transmits precise time signals to the earth, and these signals are captured by antennas and transmitted to receivers.

Furthermore, it is worth emphasizing that a receiver tracks a satellite through the signal reception, and at least four satellites are necessary to obtain a fixed 3-dimensional position. However, the use of a receiver that tracks more than four satellites simultaneously when an obstacle repeatedly blocks a signal from one of the satellites is more desirable

To do this, a receiver captures the signals from four satellites to determine its own coordinates and time, and with these data, it calculates the distance to each satellite using the time delay between the local instant and the instant when the signals were sent.

Precision receivers are also used in this GPS, and they are made up of channels and antennas. It is worth emphasizing that they do not work above the determined displacement velocity.

After the antenna captures the signals, they are directed to an electric circuit called channel, which recognizes the signals from the different satellites, as a receiver with a channel consecutively reads the signal from each satellite until all the signals of the tracked satellites are received (a technique that takes less than a second to process the data and calculate the position). It is also worth emphasizing that a receiver having more than one channel is faster because the data are processed simultaneously.

It is worth emphasizing that the antennas receive signals from the satellites that can be very low because of their low intensity.

However, it is worth stressing that this GPS has some problems, highlighted among them are: the fact that the receivers or antennas have to be in the open; the receiver has to receive from at least three satellites in order to estimate the positioning; the receiver has to receive from at least four satellites to estimate the relay; the antenna has to be completely unblocked because if there is a failure in the antenna the system loses the precise time reference, and with failures in the receiver, the system also loses the precise time reference.

To solve some of these issues, highlighting among them the direct satellite obstruction problems, the use of containers and abandoned lands (with crushed rocks) was used to construct the systems to solve problems between antennas and receivers.

Another solution to solve these issues is the use of two controllers with integrated GPS receivers, with one controller for each GPS antenna

The problem of GPS signal redundancy in the radio base stations was solved, but there is still the problem of the GPS antenna failing and controller noticing and switching to another controller at a time that can last up to 30 minutes depending on the number of radios installed in the radio base station.

### 5. TECHNOLOGICAL ADVANCEMENT

Aiming at improving this system as well as providing adequate technical alternatives, the Diversity Module Between GPS Antennas, with Receiver Protection and Integrated Alarm Signal, which implements a system whose technological advancement comprises:

The use of a diversity module between GPS antennas to solve the switching problem of the radio base stations, which adds up the signals received from the antennas and simultaneously transmits the combined signals to the other two receivers.

The use of a diversity module between GPS antennas that protects the receivers in the case of a short circuit of one of the antennas, it works with one or two receivers with advantage of using the receiver's power because it is connected in series to the antenna that is connected next to the receiver.

The use of a diversity module between GPS antennas that offers the advantage of another antenna transmitting signals to the satellite receiver without loss of synchronism in the event where an antenna fails, therefore, the receivers always receive the satellite signals.

The use of a diversity module between GPS antennas that avoids the loss of satellite signals and protects the receiver because the antenna is active and the receiver sends 5 Vdc power to the antenna, which returns the RF signals to the receiver.

The use of a diversity module between GPS antennas that increases the satellite viewing angle in space, because the receivers use two antennas instead of one.

### 6. DESCRIPTION OF DRAWINGS

To have a complete view of how this Diversity Module Between GPS Antennas, with Receiver Protection and Integrated Alarm Signal is made, issue and object of the present Patent of Invention, follow-up the illustrative drawings in annex that make references to the following:

FIG. 1: Corresponds to the block diagram of the diversity module between GPS antennas assembled between two antennas and two receivers.

FIG. 2: Shows the block diagram of the diversity module between GPS antennas assembled in vehicle systems.

FIG. 3: Explains the block diagram of the diversity module between GPS antennas assembled with a radio base system—RBS

FIG. 4: Refers to the block diagram of the diversity module between GPS antennas assembled with a microwave or optic fiber radio.

### 7. DESCRIPTION OF THE INVENTION

As shown in the drawings that are in integral part of this report, the Diversity Module Between GPS Antennas, with Receiver Protection and Integrated Alarm Signal (1), characterized by comprising a GPS receiver (2) and antennas (3).

This system (1) works with two receivers (2) and two antennas (3) with the aim of protecting the receivers (2) of the GPS by eliminating its obstruction problems, emphasizing that it has an alarm for failures that may occur, as well as help in the switching between both receivers (2) when one of them develops a fault.

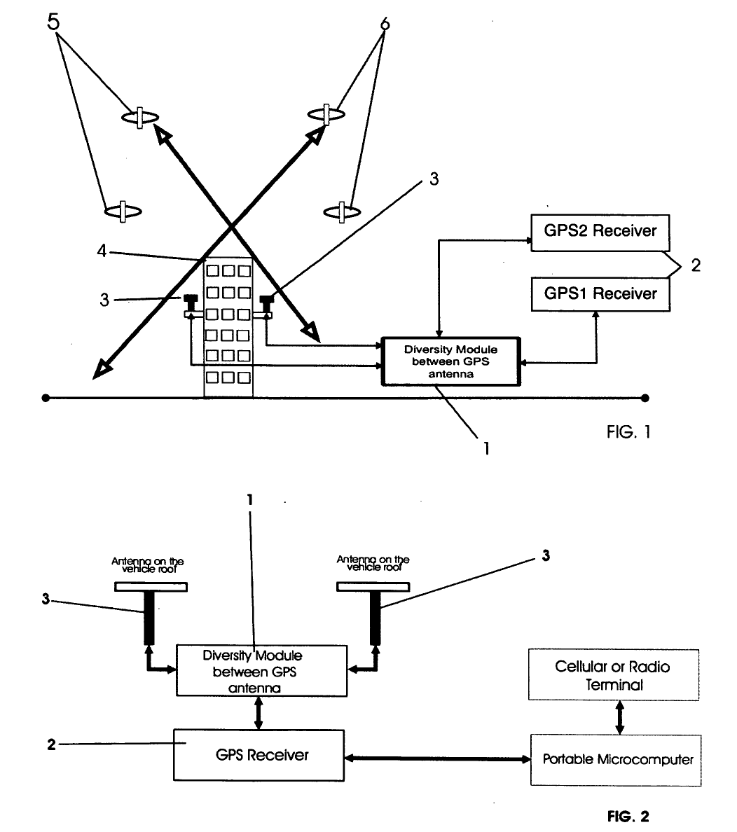

In FIG. 1, it can be seen that both antenna 1 (3) and antenna 2 (3) are blocked by the building (4) and antenna 1 (3) can only receive signals from satellites on the left (5) and antenna 2 (3) from satellites on the right (6)

In this setting, the antennas (3) are connected to the diversity module (1) which combines antenna 1 and 2 (3) signals and transmits the combined signals to the two receivers (2), therefore, the two receivers (2) receive the signals from the four satellites (5) and (6).

In FIG. 2, a second situation can be observed, if the GPS antenna fails (3) the test is not lost because the signal is simultaneously received by two GPS antennas (3).

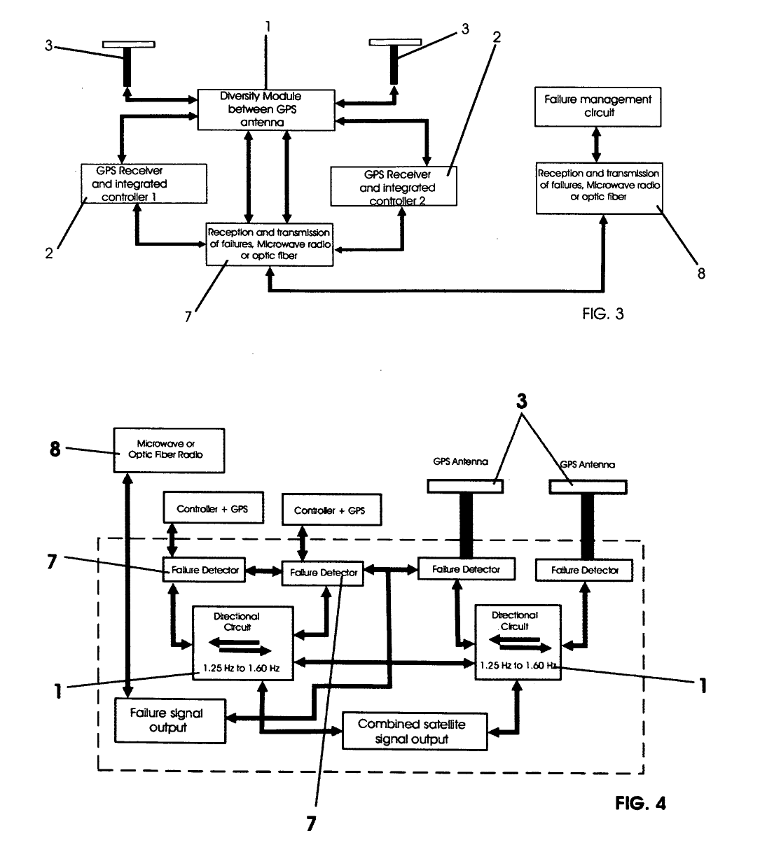

In another situation as shown in FIG. 3, if one of the GPS antennas (3) fails, a failure signal is automatically sent to the failure management (7) indicating that antenna (3) 1 or 2 failed, with emphasis on the fact that what failed was the antenna (3) and not the GPS receiver (2), so the controller does not switch to backup.

In a fourth situation as shown in FIG. 4, the failed antennas (3) are detected and sent through signals to a microwave (8) or optic fiber radio, which transmits it up to the failure management (7) network that, after being viewed, moves a technician to the location to repair the detected failures.

It also worth emphasizing that the GPS antenna (3) failures are transmitted to a microwave (8) or optic fiber radio through an open contact in the case of failures and through a closed contact in the case of normal operation.

### 8. CONCLUSION

It can be seen from what was described and illustrated above, that it is a Diversity Module Between GPS Antennas, with Receiver Protection and Integrated Alarm Signal (1), which perfectly fits into the standards of the Patent of Invention, filling the important void in the market, more especially for offering the advantages presented in the corresponding paragraph, therefore, deserving the respective privilege due to what was shown above.

1) “DIVERSITY MODULE BETWEEN GPS ANTENNAS, WITH RECEIVER PROTECTION AND INTEGRATED ALARM SIGNAL” (1) made up of a GPS receiver (2) and antennas (3), characterized by adding up the signals received from the antennas (3) and simultaneously transmitting the combined signals to the other two receivers (2).

2) “DIVERSITY MODULE BETWEEN GPS ANTENNAS, WITH RECEIVER PROTECTION AND INTEGRATED ALARM SIGNAL” (1), characterized according to claim 1, by being made up of a system (1) that works using two receivers (2) and two antennas (3), with the aim of protecting the system GPS receivers (2) and eliminating its obstruction problems, emphasizing that it has an alarm for possible failures that may occur, as well as aids the switching between both receivers (2) if one of them develops a fault.

3) “DIVERSITY MODULE BETWEEN GPS ANTENNAS, WITH RECEIVER PROTECTION AND INTEGRATED ALARM SIGNAL” (1), characterized according to claim 1 because the system protects the receivers (2) in the case of a short circuit of one of the antennas (3), working with one or two receivers (2) with the advantage of using the receiver's (2) power to work because it is connected in series to the antenna (3) that is connected next to the receiver (2).

4) “DIVERSITY MODULE BETWEEN GPS ANTENNAS, WITH RECEIVER PROTECTION AND INTEGRATED ALARM SIGNAL” (1), characterized according to claim 1 because it offers the advantage of another antenna (3) transmitting signals to the satellite (5) and (6) receiver (2) without loss of synchronism in the event where an antenna (3) fails, therefore, the receivers always receive the signals from the satellites (5) and (6).

5) “DIVERSITY MODULE BETWEEN GPS ANTENNAS, WITH RECEIVER PROTECTION AND INTEGRATED ALARM SIGNAL” (1), characterized according to claim 1 because the use of this system allows the increase of the viewing angle of satellites (5) and (6) in space since the receivers (2) use two antennas (3) instead of one.
